(19) United States
(12) Patent Application Publication
(10) Pub. No.: US 2026/0179102 A1
(43) Pub. Date: Jun. 25, 2026

(54) IDENTIFYING RESOURCE EFFICIENCY DEFICIT SCORE INFRASTRUCTURE RESOURCES IN CLOUD ENVIRONMENTS

(71) Applicant: International Business Machines Corporation, Armonk, NY (US)

(72) Inventors: Jignesh Karia, Thane (IN); Diptiman Dasgupta, Kolkata (IN); Sreejit Roy, Kolkata (IN); Charbak Roy, Kolkata (IN); Sudip Dutta, Parganas (IN)

(21) Appl. No.: 18/999,643

(22) Filed: Dec. 23, 2024

(51) Int. Cl. G06Q 30/018; G06Q 10/0639

(52) U.S. Cl. CPC G06Q 30/018; G06Q 10/06393

(57) ABSTRACT

A computer-implemented method that identifies resource efficiency deficit score infrastructure resources in cloud environments based on attributes that influence carbon emission controls at least one of the infrastructure resources based on the infrastructure resource efficiency deficit score of that the infrastructure resource. The infrastructure resource efficiency deficit score can equal BVt/(WBt+BVt), where BVt is a best value point and WBt is a worst value point. According to other illustrative embodiments, a computer system and a computer program product for identifying resource efficiency deficit score infrastructure resources in cloud environments are provided.

### BACKGROUND

This disclosure relates generally to identifying resource efficiency deficit (RED) score infrastructure in cloud environments and more specifically to identifying resource efficiency deficit score infrastructure resources in private and/or public cloud environments.

To meet government regulations and strict compliance requirements, every organization needs to rethink their current information technology (IT) operating model to reduce carbon emission from day-to-day operations. In the area of Green IT efforts, every organization needs to adopt various initiatives to reduce carbon emission from their implementation and operations activities.

While these initiatives provide a prescriptive way of designing and operating IT systems to reduce carbon footprint, currently there is no guidance available for organizations to determine which of these initiatives/actions may provide highest amount of carbon benefits. In the absence of such quantified guidance, sustainability personnel in various organizations struggle to identify the most impactful IT equipment or hotspot within the system that the rest of the organization needs to address with action.

Existing tools provide data on high utilization or low utilization servers, but they do not deal with carbon footprint from those servers. To achieve net zero target of an organization, emission from IT landscape is also significant, especially for financial institutions, but there is no standard method to identify such carbon hotspots to take decarbonization journey. Existing tools work on a financial/resource level optimization of IT estates, but do not provide solutions for carbon emission reduction or optimization to comply with regulations or meet goals or initiatives.

### SUMMARY

According to one illustrative embodiment, a computer-implemented method for identifying, using a set of processor units, resource efficiency deficit score infrastructure resources in private and/or public cloud environments is provided. The method includes identifying, by a number of processor units, a plurality of infrastructure resources in a cloud environment. The method includes identifying, by the number of processor units, for each of the plurality of infrastructure resources, a set of attributes that influence carbon emission. The method includes identifying, by the number of processor units, for each member of the set of attributes, an attribute influence direction equal to be 0 when a lower attribute value corresponds to a lower or unchanged carbon emission and to be 1 when a higher attribute value corresponds to lower carbon emission. The method includes collecting, by the number of processor units, a set of time-series data for the plurality of infrastructure resources at a plurality of instants separated by substantially equal time intervals. The method includes evaluating, by the number of processor units, for each of the plurality of infrastructure resources at each of the plurality of instants, an infrastructure resource efficiency deficit score. The method includes ordering in descending rank, by the number of processor units, the infrastructure resource efficiency deficit score for each of the plurality of infrastructure resources at a particular time selected from the plurality of instants. The method includes controlling at least one of the plurality of infrastructure resources based on the infrastructure resource efficiency deficit score of at least one of the plurality of infrastructure resources. Controlling can include powering-down, locking-down and/or unlocking the at least one resource efficiency deficit score infrastructure resource. The infrastructure resource efficiency deficit score can equal BVt/(WBt+BVt), where BVt is a best value point at each of the plurality of instants and WBt is a worst value point at each of the plurality of instants. According to other illustrative embodiments, a computer system and computer program product for identifying resource efficiency deficit score infrastructure resources in private and/or public cloud environments are provided.

### BRIEF DESCRIPTION OF THE DRAWINGS

FIG. 1 is a block diagram of a computing environment in accordance with an illustrative embodiment;

FIG. 2 is a block diagram of a data center equipped for identifying resource efficiency deficit score infrastructure in cloud environments in accordance with an illustrative embodiment;

FIG. 3 is a dataflow for identifying resource efficiency deficit score infrastructure in cloud environments in accordance with an illustrative embodiment;

FIG. 4 is a flowchart of a method for identifying resource efficiency deficit score infrastructure in cloud environments in accordance with an illustrative embodiment;

FIGS. 5-1 and 5-2 are flowcharts of a process for identifying resource efficiency deficit score infrastructure in cloud environments in accordance with an illustrative embodiment; and

FIG. 6 is a block diagram of a data processing system in accordance with an illustrative embodiment.

### DETAILED DESCRIPTION

Embodiments include a computer implemented method including: identifying, by a number of processor units, a plurality of infrastructure resources in a cloud environment; identifying, by the number of processor units, for each of the plurality of infrastructure resources, a set of attributes that influence carbon emission; identifying, by the number of processor units, for each member of the set of attributes, an attribute influence direction equal to be 0 when a lower attribute value corresponds to a lower or unchanged carbon emission and to be 1 when a higher attribute value corresponds to lower carbon emission; collecting, by the number of processor units, a set of time-series data for the plurality of infrastructure resources at a plurality of instants separated by substantially equal time intervals; evaluating, by the number of processor units, for each of the plurality of infrastructure resources at each of the plurality of instants, an infrastructure resource efficiency deficit score; ordering in descending rank, by the number of processor units, the infrastructure resource efficiency deficit score for each of the plurality of infrastructure resources at a particular time selected from the plurality of instants; and controlling at least one of the plurality of infrastructure resources based on the infrastructure resource efficiency deficit score of at least one of the plurality of infrastructure resources. As a result, these illustrative embodiments provide a technical effect of controlling at least one of the plurality of infrastructure resources based on the infrastructure resource efficiency deficit score of at least one of the plurality of infrastructure resources.

In some embodiments, controlling comprises powering-down the at least one resource efficiency deficit score infrastructure resource. As a result, these illustrative embodiments provide a technical effect of powering-down the at least one resource efficiency deficit score infrastructure resource.

In some embodiments, responsive to powering-down, locking-down the at least one resource efficiency deficit score infrastructure resource. As a result, these illustrative embodiments provide a technical effect of locking-down the at least one resource efficiency deficit score infrastructure resource.

In some embodiments, responsive to locking, un-locking the at least one resource efficiency deficit score infrastructure resource. As a result, these illustrative embodiments provide a technical effect of un-locking the at least one resource efficiency deficit score infrastructure resource.

In some embodiments, the plurality of infrastructure resource efficiency deficit scores represent at least in part energy consumption during the particular time. As a result, these illustrative embodiments provide a technical effect of the plurality of infrastructure resource efficiency deficit scores representing at least in part energy consumption during the particular time.

In some embodiments, the infrastructure resource efficiency deficit score equals BVt/(WBt+BVt), where BVt is a best value point at each of the plurality of instants and WBt is a worst value point at each of the plurality of instants. As a result, these illustrative embodiments provide a technical effect of the infrastructure resource efficiency deficit score equaling BVt/(WBt+BVt), where BVt is a best value point at each of the plurality of instants and WBt is a worst value point at each of the plurality of instants.

In some embodiments, the set of attributes comprise fixed energy consumption and variable energy consumption. As a result, these illustrative embodiments provide a technical effect of the set of attributes comprising fixed energy consumption and variable energy consumption.

In some embodiments, the plurality of infrastructure resources comprise information technology resources. As a result, these illustrative embodiments provide a technical effect of the plurality of infrastructure resources comprising information technology resources.

In some embodiments, the plurality of infrastructure resources comprise non-information technology resources. As a result, these illustrative embodiments provide a technical effect of the plurality of infrastructure resources comprise non-information technology resources.

In some embodiments, the cloud environment comprises a public cloud environment. As a result, these illustrative embodiments provide a technical effect of the cloud environment comprising a public cloud environment.

In some embodiments, the cloud environment comprises a private cloud environment. As a result, these illustrative embodiments provide a technical effect of the cloud environment comprises a private cloud environment.

Embodiments include a computer system comprising: a processor set; a set of one or more computer-readable storage media; program instructions, collectively stored in the set of one or more storage media, for causing the processor set to perform the following computer operations: identifying, by a number of processor units, a plurality of infrastructure resources in a cloud environment; identifying, by the number of processor units, for each of the plurality of infrastructure resources, a set of attributes that influence carbon emission; identifying, by the number of processor units, for each member of the set of attributes, an attribute influence direction equal to be 0 when a lower attribute value corresponds to a lower or unchanged carbon emission and to be 1 when a higher attribute value corresponds to lower carbon emission; collecting, by the number of processor units, a set of time-series data for the plurality of infrastructure resources at a plurality of instants separated by substantially equal time intervals; evaluating, by the number of processor units, for each of the plurality of infrastructure resources at each of the plurality of instants, an infrastructure resource efficiency deficit score; ordering in descending rank, by the number of processor units, the infrastructure resource efficiency deficit score for each of the plurality of infrastructure resources at a particular time selected from the plurality of instants; and controlling at least one of the plurality of infrastructure resources based on the infrastructure resource efficiency deficit score of at least one of the plurality of infrastructure resources. As a result, these illustrative embodiments provide a technical effect of controlling at least one of the plurality of infrastructure resources based on the infrastructure resource efficiency deficit score of at least one of the plurality of infrastructure resources.

In some embodiments, controlling comprises powering-down the at least one resource efficiency deficit score infrastructure resource. As a result, these illustrative embodiments provide a technical effect of powering-down the at least one resource efficiency deficit score infrastructure resource.

In some embodiments, responsive to powering-down, locking-down the at least one resource efficiency deficit score infrastructure resource. As a result, these illustrative embodiments provide a technical effect of locking-down the at least one resource efficiency deficit score infrastructure resource.

In some embodiments, responsive to locking, un-locking the at least one resource efficiency deficit score infrastructure resource. As a result, these illustrative embodiments provide a technical effect of un-locking the at least one resource efficiency deficit score infrastructure resource.

In some embodiments, the plurality of infrastructure resource efficiency deficit scores represent at least in part energy consumption during the particular time. As a result, these illustrative embodiments provide a technical effect of the plurality of infrastructure resource efficiency deficit scores representing at least in part energy consumption during the particular time.

In some embodiments, the infrastructure resource efficiency deficit score equals BVt/(WBt+BVt), where BVt is a best value point at each of the plurality of instants and WBt is a worst value point at each of the plurality of instants. As a result, these illustrative embodiments provide a technical effect of the infrastructure resource efficiency deficit score equaling BVt/(WBt+BVt), where BVt is a best value point at each of the plurality of instants and WBt is a worst value point at each of the plurality of instants.

In some embodiments, the set of attributes comprise fixed energy consumption and variable energy consumption. As a result, these illustrative embodiments provide a technical effect of the set of attributes comprising fixed energy consumption and variable energy consumption.

Embodiments include a computer program product comprising: a set of one or more computer-readable storage media; program instructions, collectively stored in the set of one or more storage media, for causing a processor set to perform the following computer operations: identifying, by a number of processor units, a plurality of infrastructure resources in a cloud environment; identifying, by the number of processor units, for each of the plurality of infrastructure resources, a set of attributes that influence carbon emission; identifying, by the number of processor units, for each member of the set of attributes, an attribute influence direction equal to be 0 when a lower attribute value corresponds to a lower or unchanged carbon emission and to be 1 when a higher attribute value corresponds to lower carbon emission; collecting, by the number of processor units, a set of time-series data for the plurality of infrastructure resources at a plurality of instants separated by substantially equal time intervals; evaluating, by the number of processor units, for each of the plurality of infrastructure resources at each of the plurality of instants, an infrastructure resource efficiency deficit score; ordering in descending rank, by the number of processor units, the infrastructure resource efficiency deficit score for each of the plurality of infrastructure resources at a particular time selected from the plurality of instants; and controlling at least one of the plurality of infrastructure resources based on the infrastructure resource efficiency deficit score of at least one of the plurality of infrastructure resources. As a result, these illustrative embodiments provide a technical effect of controlling at least one of the plurality of infrastructure resources based on the infrastructure resource efficiency deficit score of at least one of the plurality of infrastructure resources.

In some embodiments, controlling comprises powering-down the at least one resource efficiency deficit score infrastructure resource. As a result, these illustrative embodiments provide a technical effect of powering-down the at least one resource efficiency deficit score infrastructure resource.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Embodiments can help organizations to identify impactful equipment dynamically in a scientific fashion, so that they can take informed decisions on decarbonization. Embodiments can measure Resource Efficiency Deficit (RED) Score of their assets with respect to combinations of parameters (attributes) that result in carbon emission at an individual asset granularity.

Embodiments can include a method and system to dynamically identify Resource Efficiency Deficit (RED) scores (for both IT and Non-IT assets) in an IT estate which are emitting more carbon or consuming more energy compared to what it is supposed to emit so that enterprise can take informed decisions and subsequent actions.

Embodiments can include a method and system to locate hotspots in the public and private infrastructure ecosystem to reduce carbon emissions while preserving system efficiency.

Embodiments can include a method and system for calculating and identifying assets with least utilization while consuming maximum energy. (High static energy and lower dynamic energy and utilization.)

Embodiments can include a method and system for using historical data of IT assets consisting of CPU utilization, CPU allocated, memory allocated, disk usage, GPUs, PUE, Carbon Intensity (CI) etc. to use as input to identify best and worst assets based on Euclidian distance.

Embodiments can include a method and system for using time series records of various attributes to form point-in-time observations in a multi-dimensional vector space and ordering them based on their distance (using Euclidian distance) ratio from best point and worst point.

Embodiments can include a method and system to dynamically identify Resource Efficiency Deficit (RED) Score across IT (Compute/Network/Storage) & Non-IT infrastructure resources (Coolers/Chillers/HVAC etc.)

Embodiments can include a method and system to identify hotspots using resource utilization factors (CPU, Memory, Disk, Network), along with non-resource utilization factors/environment metrics (e.g. PUE, Carbon Intensity (CI)).

Input parameters can include:
List of Assets (IT and/or Non-IT) V=[V₁, V₂, . . . , V_{N}]. For example, CMDB, IT/Non-IT Asset Inventory list.

Identified list of input parameters P=[P₁, P₂, . . . , P_{K}]. For example, the input parameters could be IT/Non-IT equipment utilization, number of cores allocated, maximum energy ratings, disk size, memory size, amount of data transferred over network, GPU cores, number of TPU cores, Carbon Intensity of the DC, PUE of the DC, etc.

List of parameter direction D=[D₁, D₂, . . . , D_{K}] where Dᵢ can be of value 0 or 1. For example, for utilization the D value would be 1 (higher utilization affects the Resource Efficiency Deficit (RED) Score positively), whereas D value of CI would be 0 as lower CI values impacts the Resource Efficiency Deficit (RED) Score positively. The function BestValue for a parameter P₁ is defined as Maximum of values captured for P₁ when D value of the parameter P₁ is 1. The function BestValue for a parameter P₁ is defined as Minimum of values captured for P₁ when D value of the parameter P₁ is 0. The function Worst Value for a parameter P₁ is defined as Minimum of values captured for P₁ when D value of the parameter P₁ is 1. The function Worst Value for a parameter P₁ is defined as Maximum of values captured for P₁ when D value of the parameter P₁ is 0.

Time series value of parameters in set P, at time instants [T₁, T₂, . . . , T_{M}] for each of the Assets in list V. For all the assets, time series values must be captured over the same time-period. For example, depending on the type of parameters, the source of this time series data may vary, e.g., utilization figures could be captured from APM/ARM tools, CPU configurations may be collected from CMDB.

Output parameters can include:
Resource Efficiency Deficit (RED) Scores of the assets in list V, with respect to combination of parameters that leads to most carbon emission for the time frame in the input time-series in descending order. Assets in the top of the list are higher carbon emitters compare to assets appearing at the end of list. Resource Efficiency Deficit (RED) Score of the IT assets are numbers between 0 to 1 where lower numbers means comparatively lower carbon emitters over a period, whereas values near to 1 indicates higher carbon emission compared to other IT/Non-IT assets.

A sequence of steps can include:
Identify the IT/Non-IT assets to review for Resource Efficiency Deficit (RED) Score from appropriate sources.
Identify the list of attributes P₁, P₂ . . . P_{N} that influences the carbon emission of assets under review. e.g. Utilization, CI, PUE, CPU, GPU cores.
Identify the influence of each attribute as 0 (when lower value means lower carbon emmision. eg. CI, PUE) and as 1 (when higher value is better with regard to carbon emission e.g. utilization).
Collect the value of all the identified attributes for all the assets from appropriate source at equal time intervals as time-series data.
For each attribute Pᵢ in P₁, P₂ . . . P_{N}: Collect all the time series values of all the assets and order them in ascending order of time stamp. Store them in vector V_{Pi}.
For each attribute Pᵢ in P₁, P₂ . . . P_{N}: Collect all the time series values of all the assets and order them in ascending order of time stamp. Store them in vector V_{Pi}.
For each attribute Pᵢ in P₁, P₂ . . . P_{N}: Create a vector NV_{Pi} from V_{Pi} where NV_{Pij}=V_{Pij}/SquareRoot(SQPᵢ).
Identify Best Value point of each asset at a particular timestamp.
Define worst Value point of each asset at a particular timestamp.
For each time instant t define DBₜ=Euclidean Distance between AVₜ and BV point.
For each time instant t define WBₜ=Euclidean Distance between AVₜ and WV point.
At each time instant define Resource Efficiency Deficit (RED) Scoreₜ.
Order Resource Efficiency Deficit (RED) Scoreₜ in descending order and identify assets associated with the time instant t. Asset with high RED score marked as worst asset at that given point and marked as hotspot in the IT estate.

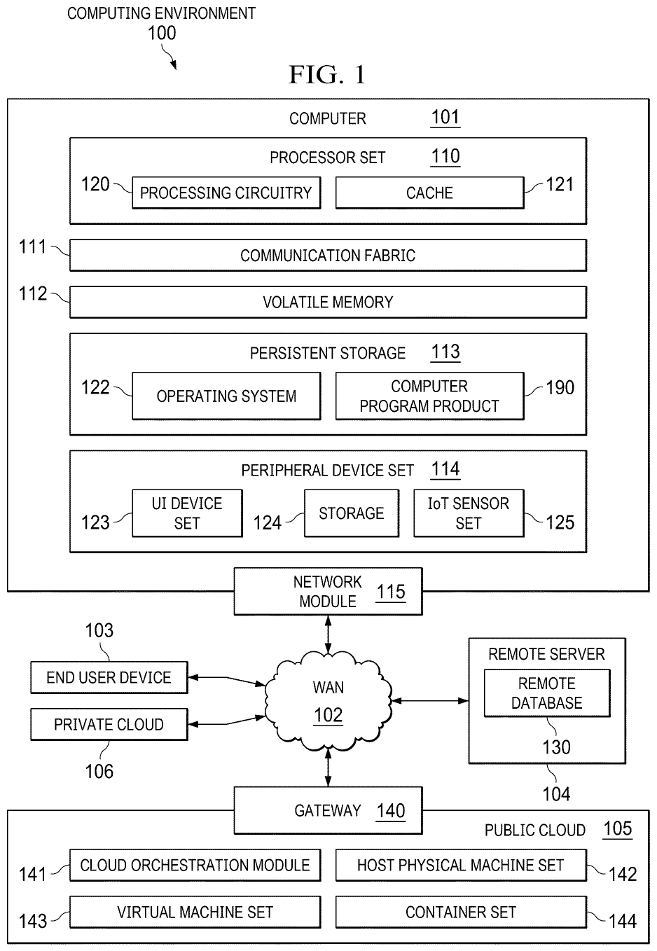

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods. Embodiments of this disclosure can be embodied in computer program product 190. In addition to computer program product 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and computer program product 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile sequestering device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in computer program product 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in computer program product 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “correlating” means determining or establishing a mutual relationship or connection or pattern, in which one thing affects, reacts, or depends on another, whether causal or not. For example, establishing, calculating, and/or measuring a relationship between 2 or more variables, such as determining a linear relationship or curve fitting a non-linear relationship.

As used herein, “a number of” when used with reference to items, means one or more items. For example, “a number of parameters” is one or more parameters. As another example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

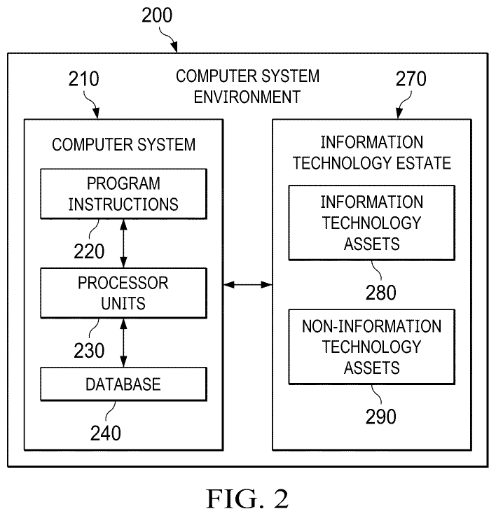

With reference now to FIG. 2, a block diagram of a computer system environment 200 is depicted in accordance with an illustrative embodiment. In this illustrative example, computer system environment 200 includes components that can be implemented in hardware such as the hardware shown in computing environment 100 in FIG. 1.

Data center environment 200 includes computer system 210. Computer system 210 includes program instructions 220. Computer system 210 includes processor units 230. Computer system 210 includes database 240. Program instructions 220, processor units 230 and database 240 interact with one another.

The computer system environment 200 also includes information technology estate 270. Information technology estate 270 includes information technology assets 280. Information technology estate 270 includes non-information technology assets 290. Information technology estate 270 interacts with computer system 210.

Program instructions 220 and database 240 may be termed a resource efficiency deficit (RED) score identifier. In particular, program instructions 220 and database 240 may be deployed with and/or implemented using computer program product 190 in FIG. 1.

Program instructions 220 and database 240 can be implemented in software, hardware, firmware or a combination thereof. When software is used, the operations performed by program instructions 220 and database 240 can be implemented using program instructions 220 configured to run on hardware, such as processor units 230. When firmware is used, the operations performed by program instructions 220 and database 240 can be implemented in program instructions and data and stored in persistent memory to run on a processor unit. When hardware is employed, the hardware can include circuits that operate to perform the operations in program instructions 220 and database 240.

Computer system 210 is a physical hardware system and includes one or more data processing systems. When more than one data processing system is present in computer system 210, those data processing systems are in communication with each other using a communications medium. The communications medium can be a network. The data processing systems can be selected from at least one of a computer, a server computer, a tablet computer, or some other suitable data processing system.

As depicted, computer system 210 includes processor units 230 that are capable of executing program instructions 220 implementing processes in the illustrative examples. In other words, program instructions 220 are computer readable program instructions.

As used herein, a processor unit in processor units 230 is a hardware device and is comprised of hardware circuits such as those on an integrated circuit that respond to and process instructions and program code that operate a computer. A processor unit can be implemented using processor set 110 in FIG. 1. When processor units 230 execute program instructions 220 for a process, processor units 230 can be one or more processor units that are in the same computer or in different computers. In other words, the process can be distributed between processor units on the same or different computers in computer system 210.

Further, the processor units 230 can be of the same type or different types of processor units. For example, the processor units 230 can be selected from at least one of a single core processor, a dual-core processor, a multi-processor core, a general-purpose central processing unit (CPU), a graphics processing unit (GPU), a digital signal processor (DSP), or some other type of processor unit.

Computer system 210 can be configured to perform at least one of the steps, operations, or actions described in the different illustrative examples using software, hardware, firmware or a combination thereof. As a result, computer system 210 operates as a special purpose computer system in which program instructions 220 and database 240 in computer system 210 enables identifying, by a number of processor units, a plurality of infrastructure resources in a cloud environment; identifying, by the number of processor units, for each of the plurality of infrastructure resources, a set of attributes that influence carbon emission; identifying, by the number of processor units, for each member of the set of attributes, an attribute influence direction equal to be 0 when a lower attribute value corresponds to a lower or unchanged carbon emission and to be 1 when a higher attribute value corresponds to lower carbon emission; collecting, by the number of processor units, a set of time-series data for the plurality of infrastructure resources at a plurality of instants separated by substantially equal time intervals; evaluating, by the number of processor units, for each of the plurality of infrastructure resources at each of the plurality of instants, an infrastructure resource efficiency deficit score; ordering in descending rank, by the number of processor units, the infrastructure resource efficiency deficit score for each of the plurality of infrastructure resources at a particular time selected from the plurality of instants; and controlling at least one of the plurality of infrastructure resources based on the infrastructure resource efficiency deficit score of at least one of the plurality of infrastructure resources. In particular, program instructions 220 and database 240 transforms computer system 210 into a special purpose computer system as compared to currently available general computer systems that do not have program instructions 220 and database 240 because of the special purpose steps enabled by program instructions 220 and database 240.

In the illustrative example, the use of program instructions 220 and database 240 in computer system 210 integrates processes into a practical application for controlling at least one of the plurality of infrastructure resources that can reduce the carbon emissions of information technology estate 270. In other words, program instructions 220 and database 240 in computer system 210 are directed to a practical application of processes integrated into computer system 210 that controls at least one of the plurality of infrastructure resources that can reduce the carbon emissions of information technology estate 270.

The illustration of the computer system 212 and computer system environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

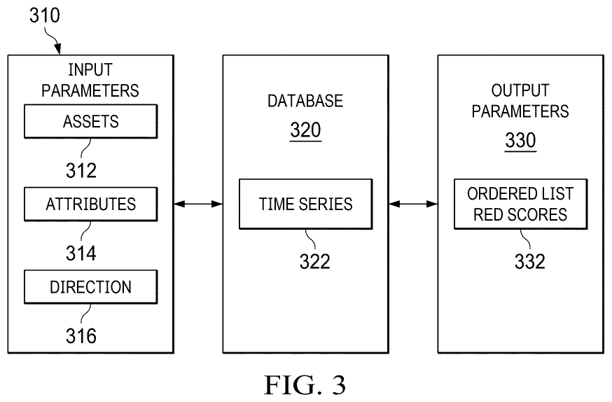

Turning next to FIG. 3, a dataflow diagram of embodiments of this disclosure is depicted. The data in block 310 can be termed input parameters. Block 310 includes data regarding assets 312, data regarding attributes 314 and data regarding directionality 316. The data in block 320 can be termed database. Block 320 includes data regarding time series 322. The data in block 330 can be termed output parameters. The data in block 330 includes ordered list of RED scores 332. The data in block 310 interacts with the data in block 320 and the data in block 330. The data in block 320 interacts with the data in block 310 and the data in block 330. The data in block 330 interacts with the data in block 320 and the data in block 310.

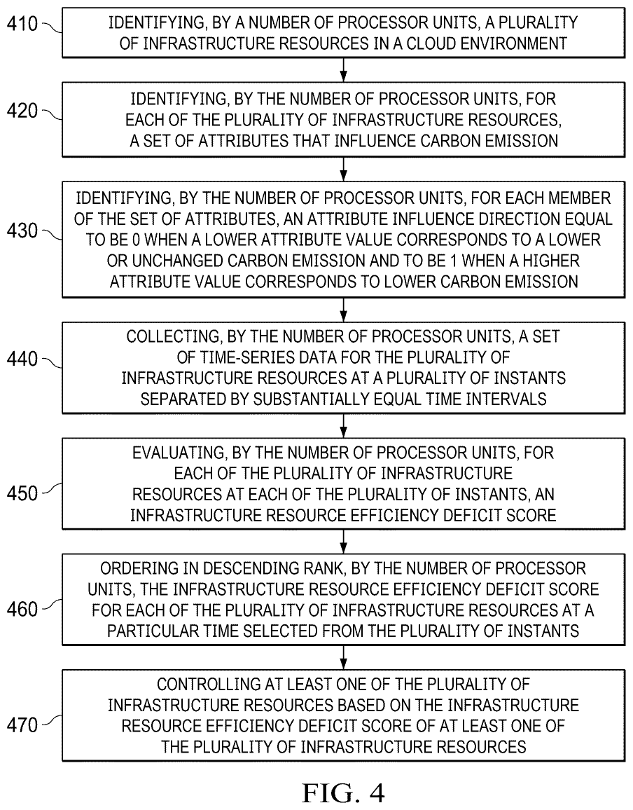

Turning next to FIG. 4, a flowchart of a process for identifying resource efficiency deficit score infrastructure resources in private and/or public cloud environments is depicted in accordance with an illustrative embodiment. Embodiments are not limited to the sequence of steps shown in FIG. 4. The process in FIG. 4 can be implemented in hardware, software, or both. When implemented in software, the process can take the form of program instructions that are run by one of more processor units located in one or more hardware devices in one or more computer systems. For example, the process of FIG. 4 can be implemented in program instructions 220 and database 240 in computer system 210 in FIG. 2.

Block 410 identifies, by a number of processor units, a plurality of infrastructure resources in a cloud environment. Block 420 identifies, by the number of processor units, for each of the plurality of infrastructure resources, a set of attributes that influence carbon emission. Block 430 identifies, by the number of processor units, for each member of the set of attributes, an attribute influence direction equal to be 0 when a lower attribute value corresponds to a lower or unchanged carbon emission and to be 1 when a higher attribute value corresponds to lower carbon emission. Block 440 collects, by the number of processor units, a set of time-series data for the plurality of infrastructure resources at a plurality of instants separated by substantially equal time intervals. Block 450 evaluates, by the number of processor units, for each of the plurality of infrastructure resources at each of the plurality of instants, an infrastructure resource efficiency deficit score. Block 460 orders in descending rank, by the number of processor units, the infrastructure resource efficiency deficit score for each of the plurality of infrastructure resources at a particular time selected from the plurality of instants. Block 470 controls at least one of the plurality of infrastructure resources based on the infrastructure resource efficiency deficit score of at least one of the plurality of infrastructure resources.

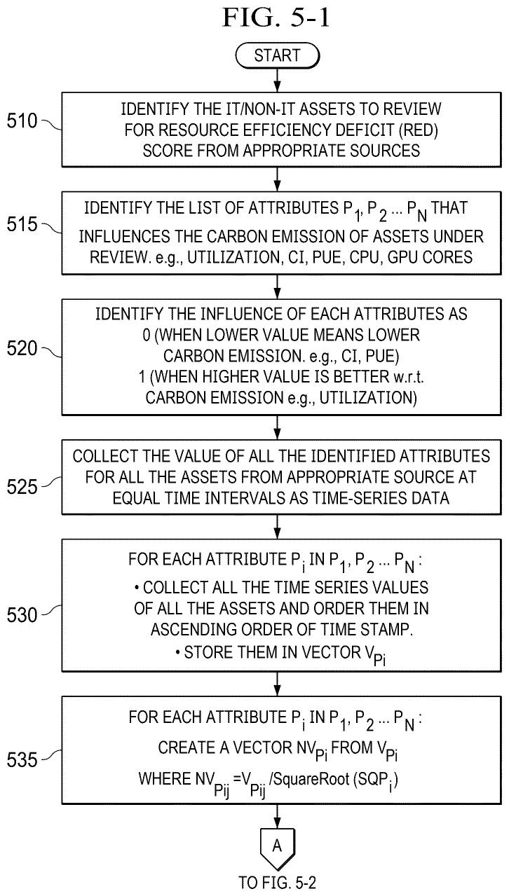

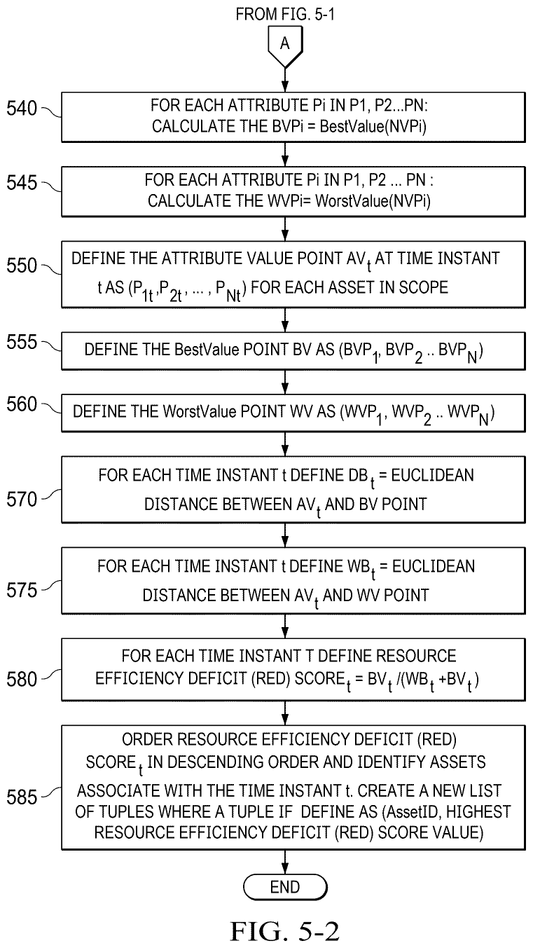

Turning now to FIG. 5, a flowchart of a process for identifying resource efficiency deficit score infrastructure resources in private and/or public cloud environments is depicted in accordance with an illustrative embodiment. Embodiments are not limited to the sequence of steps shown in FIG. 5. The process in FIG. 5 can be implemented in hardware, software, or both. When implemented in software, the process can take the form of program instructions that are run by one of more processor units located in one or more hardware devices in one or more computer systems. For example, the process of FIG. 5 can be implemented in program instructions 220 and database 240 in computer system 210 in FIG. 2.

Block 510 identifies the IT and/or Non-IT assets to review for Resource Efficiency Deficit (RED) Score from appropriate sources. Block 515 identifies the list of attributes P₁, P₂ . . . P_{N} that influences the carbon emission of assets under review. e.g. Utilization, CI, PUE, CPU, GPU cores. Block 520 identifies the influence of each attributes as 0 (When lower value means lower carbon emission. e.g., CI, PUE) and as 1 (When higher value is better w.r.t. carbon emission e.g., Utilization). Block 525 collects the value of all the identified attributes for all the assets from appropriate source at equal time intervals as time-series data. Block 530, for each attribute Pᵢ in P₁, P₂ . . . P_{N}, collects all the time series values of all the assets and order them in ascending order of time stamp, and stores them in vector V_{Pi}. Block 535, for each attribute Pᵢ in P₁, P₂ . . . P_{N}, creates a vector NV_{Pi} from V_{Pi} where NV_{Pij}=V_{Pij}/SquareRoot(SQPᵢ). Block 540, for each attribute Pi in P1, P2 . . . PN, calculates the BVPi=BestValue(NVPi). Block 545, for each attribute Pi in P1, P2 . . . PN, calculates the WVPi=WorstValue(NVPi). Block 550 defines the attribute value point AVₜ at time instant t as (P₁ₜ, P₂ₜ, . . . , P_{Nt}) for each asset in scope. Block 555 defines the Best Value point BV as (BVP₁, BVP₂ . . . BVP_{N}). Block 560 defines the Worst Value point WV as (WVP₁, WVP₂ . . . WVP_{N}). Block 570, for each time instant t, defines DBₜ=Euclidean Distance between AVₜ and BV point. Block 575, for each time instant t, defines WBₜ=Euclidean Distance between AVₜ and WV point. Block 580, for each time instant t, defines Resource Efficiency Deficit (RED) Scoreₜ=BVₜ/(WBₜ+BVₜ). Block 585 orders the Resource Efficiency Deficit (RED) Scoreₜ in descending order and identifies assets associated with the time instant t. Block 585 also creates a new list of tuples where a tuple if define as (AssetID, highest Resource Efficiency Deficit (RED) Score value).

Of course, embodiments are not limited to the sequence of steps shown in FIG. 4 and/or FIG. 5 and embodiments are open to other functions such as decision blocks as well as being open to additional step(s).

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

A practical application of an embodiment of the present disclosure that has value within the technological arts is where one or more infrastructure resources identified with out of tolerance resource efficiency deficit scores are shut-down including actuating one or more electrical relays to disconnect electrical power from those one or more infrastructure resources. Another practical application of an embodiment of the present disclosure that has value within the technological arts is where at least one of the one or more shut down infrastructure resources are locked down requiring mechanical unlocking, electrical reset and/or software release to open. There are virtually innumerable uses for embodiments of the present disclosure, all of which need not be detailed here.

A specific exemplary embodiment will now be further described by the following, nonlimiting example which will serve to illustrate various features in some detail. The following example is included to facilitate an understanding of ways in which embodiments of the present disclosure may be practiced. However, it should be appreciated that many changes can be made in the exemplary embodiment which is disclosed while still obtaining like or similar result without departing from the scope of embodiments of the present disclosure. Accordingly, the example should not be construed as limiting the scope of the present disclosure.

### Given

1. List of Assets (IT and/or Non-IT) V=[V₁, V₂, . . . , V_{N}]
2. List of parameters P=[P₁, P₂, . . . , P_{K}]
3. List of parameter direction D=[D₁, D₂, . . . , D_{K}] where Dᵢ can be of value 0 or 1
4. Time series value of parameters in set P, at time instants [T₁, T₂, . . . , T_{M}] for each of the Assets in list V

### Problem

1. To measure Resource Efficiency Deficit (RED) Score of the Assets in set V with respect to combination of parameters (mentioned in list P) that leads to most carbon emission.

### Process

1. Create a 2-dimensional matrix V0 of size S×K
   1.1. Where K=# of parameters
   1.2. S=N(# of Assets)*M (# of time instants)
2. Create a Map M<Integer, Integer>
3. Initialize V0 as following
   3.1. Set L=0
   3.2. For each Asset Vᵢ in [V₁, V₂, . . . , V_{N}]
      3.2.1. For each time instant Tⱼ in [T₁, T₂ . . . , T_{M}]
      3.2.2. Let PVᵢ=Set of values of the parameters P of Asset Vᵢ at instant Tⱼ
      3.2.3. Set V0[L]=PVᵢ
      3.2.4. Set M<L>=i (The index of the Asset Vᵢ, i.e. i withing the list V)
      3.2.5. Set L=L+1
4. Define a 2-dimensional matrix SQ1 of dimension S×K where
   4.1. Where K=# of parameters
   4.2. S=N(# of Assets)*M (# of time instants)
5. For each column I in V0
   5.1. Set

$$SS = {\sum }_{j = 0}^{N * M} {V 0 [ j ] [ I ]}^{2}$$

5.2. For each row J of column, I of V0
6. Define a 2-dimensional matrix SQ2 of dimension S×K where
   6.1. Where K=# of parameters
   6.2. S=N(# of Assets)*M (# of time instants)
7. For each row J in SQ1
   7.1. Get W=GetWeight(V0[J]) (GetWeight function returns a vector of size K (# of parameters))
   7.2. For each column I of row, J of SQ1
      7.2.1. Set SQ2 [J][I]=SQ1[J][I]*Wᵢ
8. Define 2 vectors B and W of size K
9. For each element Dᵢ in parameter direction list D=[D₁, D₂, . . . , D_{K}]
   9.1. If Dᵢ=0 then
      9.1.1. Set B[i]=Minimum of value of the elements of the column I of matrix SQ2
      9.1.2. Set W[i]=Maximum of value of the elements of the column I of matrix SQ2
   9.2. If Dᵢ=1 then
      9.2.1. Set B[i]=Maximum of value of the elements of the column I of matrix SQ2
      9.2.2. Set W[i]=Minimum of value of the elements of the column I of matrix SQ2
10. Define a vector SI of size N*M
11. For row J in SQ2
   11.1. Set

$$EDB = \sqrt{{\sum }_{i = 0}^{K} {( SQ 2 [ J ] [ i ] - B [ i ] )}^{2}}$$

11.2. Set

$$EDW = \sqrt{{\sum }_{i = 0}^{K} {( SQ 2 [ J ] [ i ] - W [ i ] )}^{2}}$$

11.3. Set SI [J]=EDB/(EDB+EDW)
12. Create a list of objects R where each element of R consists of 2 attributes viz AssetID, and Resource Efficiency Deficit (RED) Score
13. For each Vᵢ in [V₁, V₂, . . . , V_{N}]
   13.1. Set COUNT=0
   13.2. Set T=0
   13.3. For each entry R_{J} in SI vector
      13.3.1. Set ASSET_ID=M<J>
      13.3.2. If ASSET_ID==i (i.e. the index of Vᵢ) then
         13.3.2.1. Set COUNT=COUNT+1
         13.3.2.2. Set T=Max(T,Rⱼ)
   13.4. Create an object O with 2 attributes Asset, and Resource Efficiency Deficit (RED) Score
   13.5. Set O. ASSET_ID=Vᵢ
   13.6. Set O.SI=T
   13.7. Append O in the list R
   13.8. Sort the elements of R with respect to descending order of Resource Efficiency Deficit (RED) Score
14. Now the list R contains the list of Assets in the descending order of Resource Efficiency Deficit (RED) Score. The first Asset in the sorted list emits most carbon compared (due to combination of its parameter values in P) to the others. The 2^{nd} one emits 2^{nd} most carbon after the 1^{st} one and so on.

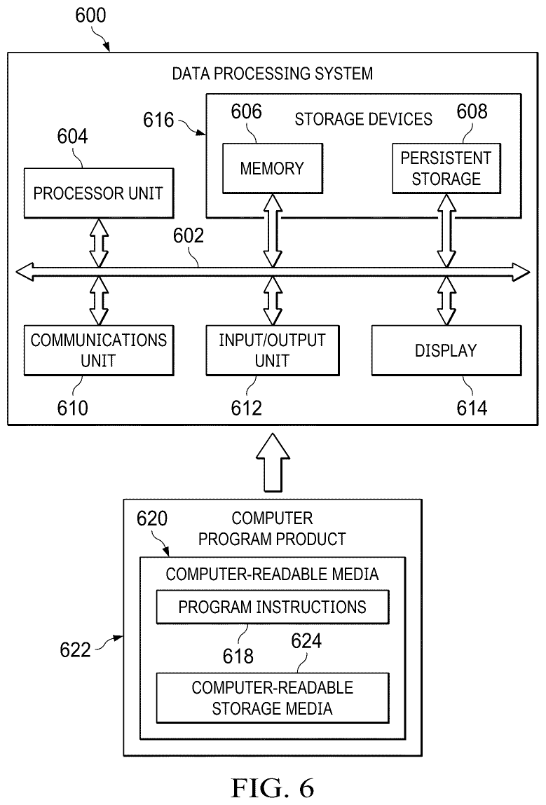

Turning now to FIG. 6, a block diagram of a data processing system is depicted in accordance with an illustrative embodiment. Data processing system 600 can be used to implement computers and computing devices in computing environment 100 in FIG. 1. Data processing system 600 can also be used to implement computer system 210 in FIG. 2. In this illustrative example, data processing system 600 includes communications framework 602, which provides communications between processor unit 604, memory 606, persistent storage 608, communications unit 610, input/output (I/O) unit 612, and display 614. In this example, communications framework 602 takes the form of a bus system.

Processor unit 604 serves to execute instructions for software that can be loaded into memory 606. Processor unit 604 includes one or more processors. For example, processor unit 604 can be selected from at least one of a multicore processor, a central processing unit (CPU), a graphics processing unit (GPU), a physics processing unit (PPU), a digital signal processor (DSP), a network processor, or some other suitable type of processor. Further, processor unit 604 can be implemented using one or more heterogeneous processor systems in which a main processor is present with secondary processors on a single chip. As another illustrative example, processor unit 604 can be a symmetric multi-processor system containing multiple processors of the same type on a single chip.

Memory 606 and persistent storage 608 are examples of storage devices 616. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 616 may also be referred to as computer readable storage devices in these illustrative examples. Memory 606, in these examples, can be, for example, a random-access memory or any other suitable volatile or non-volatile storage device. Persistent storage 608 may take various forms, depending on the particular implementation.

For example, persistent storage 608 may contain one or more components or devices. For example, persistent storage 608 can be a hard drive, a solid-state drive (SSD), a flash memory, a rewritable optical disk, a rewritable magnetic tape, or some combination of the above. The media used by persistent storage 608 also can be removable. For example, a removable hard drive can be used for persistent storage 608.

Communications unit 610, in these illustrative examples, provides for communications with other data processing systems or devices. In these illustrative examples, communications unit 610 is a network interface card.

Input/output unit 612 allows for input and output of data with other devices that can be connected to data processing system 600. For example, input/output unit 612 may provide a connection for user input through at least one of a keyboard, a mouse, or some other suitable input device. Further, input/output unit 612 may send output to a printer. Display 614 provides a mechanism to display information to a user.

Instructions for at least one of the operating system, applications, or programs can be located in storage devices 616, which are in communication with processor unit 604 through communications framework 602. The processes of the different embodiments can be performed by processor unit 604 using computer-implemented instructions, which may be located in a memory, such as memory 606.

These instructions are referred to as program instructions, computer usable program instructions, or computer readable program instructions that can be read and executed by a processor in processor unit 604. The program instructions in the different embodiments can be embodied on different physical or computer readable storage media, such as memory 606 or persistent storage 608.

Program instructions 618 are located in a functional form on computer-readable media 620 that is selectively removable and can be loaded onto or transferred to data processing system 600 for execution by processor unit 604. Program instructions 618 and computer readable media 620 form computer program product 622 in these illustrative examples. In the illustrative example, computer readable media 620 is computer readable storage media 624.

Computer-readable storage media 624 is a physical or tangible storage device used to store program instructions 618 rather than a medium that propagates or transmits program instructions 618. Computer readable storage media 624, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 618 can be transferred to data processing system 600 using a computer readable signal media. The computer readable signal media are signals and can be, for example, a propagated data signal containing program instructions 618. For example, the computer readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 620 can be singular or plural. For example, program instructions 618 can be located in computer readable media 620 in the form of a single storage device or system. In another example, program instructions 618 can be located in computer readable media 620 that is distributed in multiple data processing systems. In other words, some instructions in program instructions 618 can be located in one data processing system while other instructions in program instructions 618 can be located in one data processing system. For example, a portion of program instructions 618 can be located in computer readable media 620 in a server computer while another portion of program instructions 618 can be located in computer readable media 620 located in a set of client computers.

The different components illustrated for data processing system 600 are not meant to provide architectural limitations to the manner in which different embodiments can be implemented. In some illustrative examples, one or more of the components may be incorporated in or otherwise form a portion of, another component. For example, memory 606, or portions thereof, may be incorporated in processor unit 604 in some illustrative examples. The different illustrative embodiments can be implemented in a data processing system including components in addition to or in place of those illustrated for data processing system 600. Other components shown in FIG. 6 can be varied from the illustrative examples shown. The different embodiments can be implemented using any hardware device or system capable of running program instructions 618.

Thus, illustrative embodiments of the present disclosure provide a computer-implemented method, computer system, and computer program product for identifying resource efficiency deficit (RED) score infrastructure resources in private and/or public cloud environments. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer implemented method, comprising:
identifying, by a number of processor units, a plurality of infrastructure resources in a cloud environment;
identifying, by the number of processor units, for each of the plurality of infrastructure resources, a set of attributes that influence carbon emission;
identifying, by the number of processor units, for each member of the set of attributes, an attribute influence direction equal to be 0 when a lower attribute value corresponds to a lower or unchanged carbon emission and to be 1 when a higher attribute value corresponds to lower carbon emission;
collecting, by the number of processor units, a set of time-series data for the plurality of infrastructure resources at a plurality of instants separated by substantially equal time intervals;
evaluating, by the number of processor units, for each of the plurality of infrastructure resources at each of the plurality of instants, an infrastructure resource efficiency deficit score;
ordering in descending rank, by the number of processor units, the infrastructure resource efficiency deficit score for each of the plurality of infrastructure resources at a particular time selected from the plurality of instants; and
controlling at least one of the plurality of infrastructure resources based on the infrastructure resource efficiency deficit score of at least one of the plurality of infrastructure resources.

2. The computer implemented method of claim 1, wherein controlling comprises powering-down the at least one of the plurality of infrastructure resources.

3. The computer implemented method of claim 2, further comprising, responsive to powering-down, locking-down the at least one of the plurality of infrastructure resources.

4. The computer implemented method of claim 3, further comprising, responsive to locking, un-locking the at least one of the plurality of infrastructure resources.

5. The computer implemented method of claim 1, wherein the infrastructure resource efficiency deficit score represents at least in part energy consumption during at the particular time.

6. The computer implemented method of claim 1, wherein the infrastructure resource efficiency deficit score equals BVt/(WBt+BVt), where BVt is a best value point at each of the plurality of instants and WBt is a worst value point at each of the plurality of instants.

7. The computer implemented method of claim 1, wherein the set of attributes comprise fixed energy consumption and variable energy consumption.

8. The computer implemented method of claim 1, wherein the plurality of infrastructure resources comprise information technology resources.

9. The computer implemented method of claim 1, wherein the plurality of infrastructure resources comprise non-information technology resources.

10. The computer implemented method of claim 1, wherein the cloud environment comprises a public cloud environment.

11. The computer implemented method of claim 1, wherein the cloud environment comprises a private cloud environment.

12. A computer system comprising:
a processor set;
a set of one or more computer-readable storage media;
program instructions, collectively stored in the set of one or more storage media, for causing the processor set to perform the following computer operations:
identifying, by a number of processor units, a plurality of infrastructure resources in a cloud environment;
identifying, by the number of processor units, for each of the plurality of infrastructure resources, a set of attributes that influence carbon emission;
identifying, by the number of processor units, for each member of the set of attributes, an attribute influence direction equal to be 0 when a lower attribute value corresponds to a lower or unchanged carbon emission and to be 1 when a higher attribute value corresponds to lower carbon emission;
collecting, by the number of processor units, a set of time-series data for the plurality of infrastructure resources at a plurality of instants separated by substantially equal time intervals;
evaluating, by the number of processor units, for each of the plurality of infrastructure resources at each of the plurality of instants, an infrastructure resource efficiency deficit score;
ordering in descending rank, by the number of processor units, the infrastructure resource efficiency deficit score for each of the plurality of infrastructure resources at a particular time selected from the plurality of instants; and
controlling at least one of the plurality of infrastructure resources based on the infrastructure resource efficiency deficit score of at least one of the plurality of infrastructure resources.

13. The computer system of claim 12, wherein controlling comprises powering-down the at least one of the plurality of infrastructure resources.

14. The computer system of claim 13, further comprising, responsive to powering-down, locking-down the at least one of the plurality of infrastructure resources.

15. The computer system of claim 14, further comprising, responsive to locking, un-locking the at least one of the plurality of infrastructure resources.

16. The computer system of claim 12, wherein the infrastructure resource efficiency deficit score represents at least in part energy consumption at the particular time.

17. The computer system of claim 12, wherein the infrastructure resource efficiency deficit score equals BVt/(WBt+BVt), where BVt is a best value point at each of the plurality of instants and WBt is a worst value point at each of the plurality of instants.

18. The computer system of claim 12, wherein the set of attributes comprise fixed energy consumption and variable energy consumption.

19. A computer program product comprising:
a set of one or more computer-readable storage media;
program instructions, collectively stored in the set of one or more storage media, for causing a processor set to perform the following computer operations:
identifying, by a number of processor units, a plurality of infrastructure resources in a cloud environment;
identifying, by the number of processor units, for each of the plurality of infrastructure resources, a set of attributes that influence carbon emission;
identifying, by the number of processor units, for each member of the set of attributes, an attribute influence direction equal to be 0 when a lower attribute value corresponds to a lower or unchanged carbon emission and to be 1 when a higher attribute value corresponds to lower carbon emission;
collecting, by the number of processor units, a set of time-series data for the plurality of infrastructure resources at a plurality of instants separated by substantially equal time intervals;
evaluating, by the number of processor units, for each of the plurality of infrastructure resources at each of the plurality of instants, an infrastructure resource efficiency deficit score;
ordering in descending rank, by the number of processor units, the infrastructure resource efficiency deficit score for each of the plurality of infrastructure resources at a particular time selected from the plurality of instants; and
controlling at least one of the plurality of infrastructure resources based on the infrastructure resource efficiency deficit score of at least one of the plurality of infrastructure resources.

20. The computer program product of claim 19, wherein controlling comprises powering-down the at least one of the plurality of infrastructure resources.
